(19) United States
(12) Patent Application Publication
(10) Pub. No.: US 2010/0075289 A1
(43) Pub. Date: Mar. 25, 2010

(54) METHOD AND SYSTEM FOR AUTOMATED CONTENT CUSTOMIZATION AND DELIVERY

(75) Inventors: Ahmed E.I. Maher, Cairo (EG); Mohamed M.M.M. Kattaya, Doha (QA); Amr F. Yassin, Cairo (EG)

Correspondence Address: IBM - EU c/o Myers Andras Sherman LLP, 19900 MacArthur Blvd., Suite 1150, Irvine, CA, 92612, US

(73) Assignee: International Business Machines Corporation, Armonk, NY (US)

(21) Appl. No.: 12/234,322

(22) Filed: Sep. 19, 2008

(51) Int. Cl. G09B 7/00

(52) U.S. Cl. 434/323

(57) ABSTRACT

A method and system for automated customization of original content for one or more users, is provided. One implementation involves obtaining behavior information for a user, profiling the user based on the user behavior information, determining a preferred learning style for the user based on the user profiling, and customizing the original content based on the preferred learning style for the user. Profiling the user may involve analyzing the user behavior information using one or more profiling patterns for profiling the user to determine scores for different behavior categories for the user. Customizing the original content may involve determining a preferred learning style for the user based on the user profiling further includes selecting a customization scheme from a scheme repository, based on said scores for different behavior categories for the user, and applying the selected customization scheme to the original content to generated customized content for the user.

### BACKGROUND OF THE INVENTION

1. Field of the Invention

The present invention relates generally to content delivery and in particular to content delivery for user learning.

2. Background Information

The effectiveness of communication among humans depends on many factors. One of these factors is the personality of the recipient of a communication. Conventional approaches in conveying on-line course, for example, either provide text-based or text/audio-based material. Such material is fixed and does not change from one user recipient to another regardless of the preferred manner in which each particular recipient may learn most efficiently.

### SUMMARY OF THE INVENTION

The invention provides a method and system for automated customization of original content for one or more users. One embodiment involves obtaining behavior information for a user, profiling the user based on the user behavior information, determining a preferred learning style for the user based on the user profiling, and customizing the original content based on the preferred learning style for the user.

Profiling the user may involve analyzing the user behavior information using one or more profiling patterns for profiling the user to determine scores for different behavior categories for the user. Customizing the original content may involve determining a preferred learning style for the user based on the user profiling further including selecting a customization scheme from a scheme repository, based on said scores for different behavior categories for the user, and applying the selected customization scheme to the original content to generated customized content for the user.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows a functional block diagram of a content customization system, according to an embodiment of the invention.

FIG. 2 shows a functional block diagram of a content customization system, according to an embodiment of the invention.

FIG. 3 shows a functional block diagram of a best learning style identifier, according to an embodiment of the invention.

FIG. 4 shows a functional block diagram of a customization algorithm factory, according to an embodiment of the invention.

FIG. 5 shows a functional block diagram of a customization engine, according to an embodiment of the invention.

FIG. 6 shows an example of content customization and display, according to an embodiment of the invention.

FIG. 7 shows a functional block diagram of a World Wide Web (web-based) content customization and delivery system, according to an embodiment of the invention.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The invention provides a method and apparatus for automated customization of original content for one or more users. The invention provides a method and system for tailoring communication content, such as electronic content (eContent), to suit each individual recipient based on the best way of communication for the recipient to learn effectively.

An embodiment involves utilizing recipient personality analysis. Certain eContent is customized to the most suitable way for effective communication of the eContent to the user. The preferred way of communication of the user is based on recognizing user behavior, or based on sensors at the beginning of the process. Analysis techniques to identify the type of user personality may be used to customize the eContent, to the most suitable way for effective communication to the user.

An effective learning medium depends on the personality of each user. Linking recipient personality to a preferred way of thinking, allows determining the most effective way of learning. Known analysis techniques may be used to analyze the user personality and the best way for communication with each personality type. Each such technique uses different factors for analyzing the personality of a recipient. One example of such known techniques is Neural Language Processing (NLP) based on visual, auditory, kinesthetic, and auditory digital factors. Another known technique Whole Brain Thinking (WBT) is based on rational, organized, feeling and experiment, factors. Each of these methods uses analysis techniques to identify the type of user personality and its score in each factor.

A preferred embodiment of the invention customizes eContents for each user based on WBT or NLP profiling of that user. Such user profiling is utilized to customize eContent for maximizing the gain of the learning experience. The invention provides an automated (e.g., computer implemented) method of customizing content to suit each recipient learner's strengths in terms of learning. As such, preferred way of communication to the user is based on recognizing user behavior using sensors at the beginning of the learning process (the details of each behavior recognition are outside the scope of the present invention).

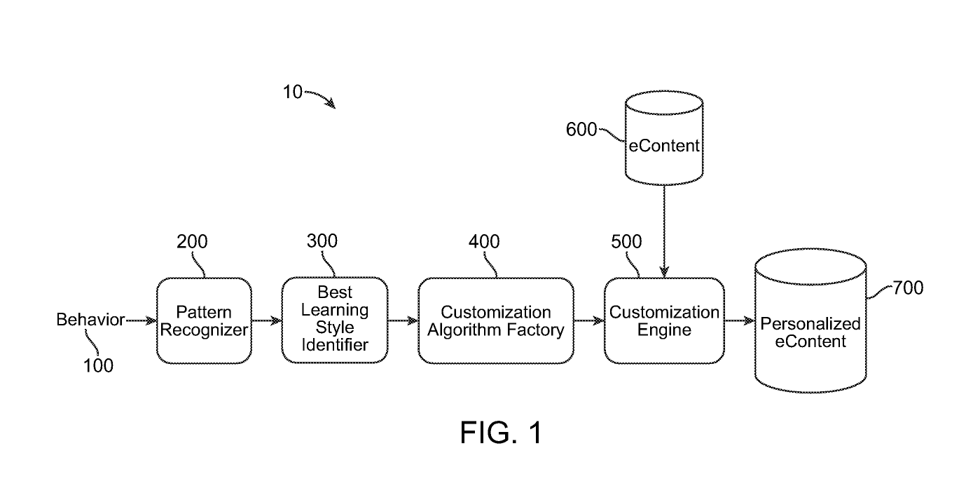

In a preferred embodiment, the present invention provides an automated method of customizing content to match the most preferable learning style for each user. FIG. 1 shows a functional block diagram of an automation system 10, according to an embodiment of the invention. The system 10 receives user behavior information 100 for a user, and analyzes the behavior information in a pattern recognizer 200 configured for recognizing and categorizing the user behavior (e.g., using NLP or WBT). A best learning style identifier 300 is configured to identify the best learning style for the user. A customization algorithm factory 400 is configured to determine a customization algorithm for the user. A customization engine 500 is configured to customize a raw eContent 600 (structured or unstructured) based on the customization algorithm and generate personalized eContent 700 that is customized to the user. The personalized eContent 700 may include video, images, text, audio, Web content or any other electronic format.

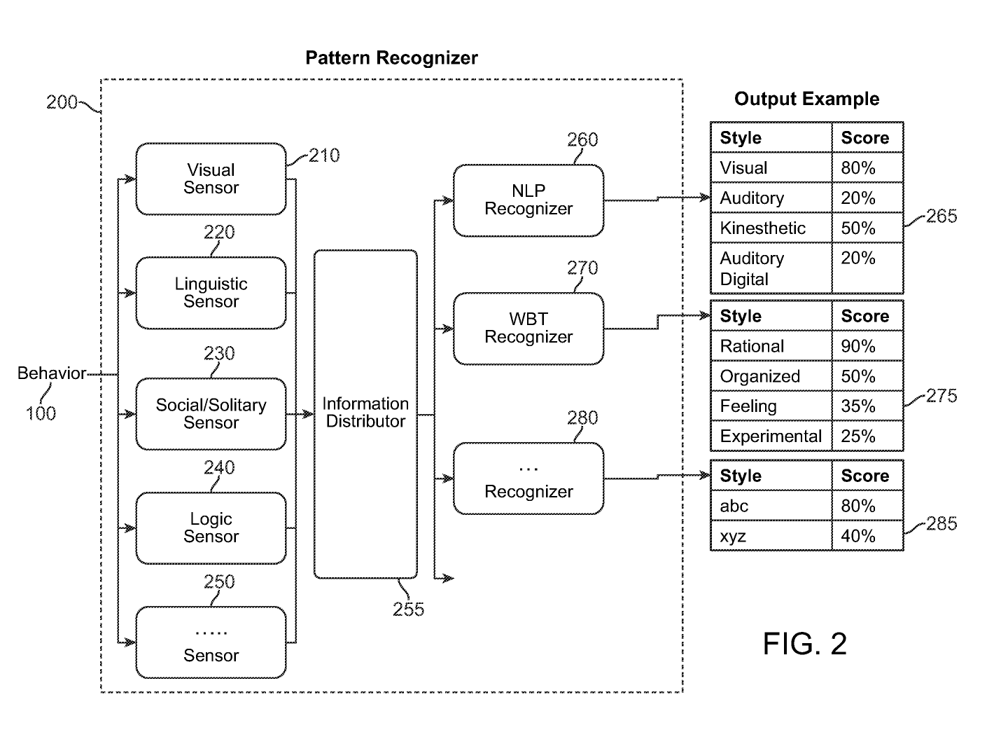

FIG. 2 shows a functional block diagram of an embodiment of the pattern recognizer 200, according to the present invention. The pattern recognizer 200 includes a sensor 210, such as a visual sensor, to sense the visual behavior of the user from the user behavior information. The sensor 210 may comprise a video camera with an analyzer that analyzes user eye movements. A linguistic sensor 220 analyzes the user behavior information to determine the type of words the user typically uses in speaking and/or writing. In one example, the sensor 220 may comprise a microphone coupled to a text analyzer (while in another example, sample text is provided to the text analyzer), to determine linguistic features of the user behavior.

A preference sensor 230 analyzes the user behavior information if the user prefers to work solitary or within a social group (an example implementation may comprise an interactive questionnaire). A logical thinking sensor 240 analyzes the user behavior information to determine tendency of the user towards logical statements and flows (an example implementation may comprise said interactive questionnaire). Other senor(s) 250 may be included to analyze other aspects of the user behavior from the user behavior information.

An information distributor 255 then selectively distributes the analyzed user behavior information from the sensors (i.e., relative information) to one or more of appropriate behavior recognizer engines (e.g., NLP recognizer engine 260, WBT recognizer engine 270, or other recognizer engine(s) 280). For example, the NLP recognizer engine 260 uses the sensed user information distributed to it by the information distributor 255, to analyze the user behavior based on NLP pattern, generating category pattern scores result 265. The WBT recognizer engine 270 analyzes the user behavior based on WBT pattern, generating a category pattern scores result 275. Other recognizer engines 280 may analyze the user behavior based on other patterns (generating category pattern score results 285). The category where the user belongs may vary from time-to-time or in different contexts (e.g., learning at work is different than learning at home).

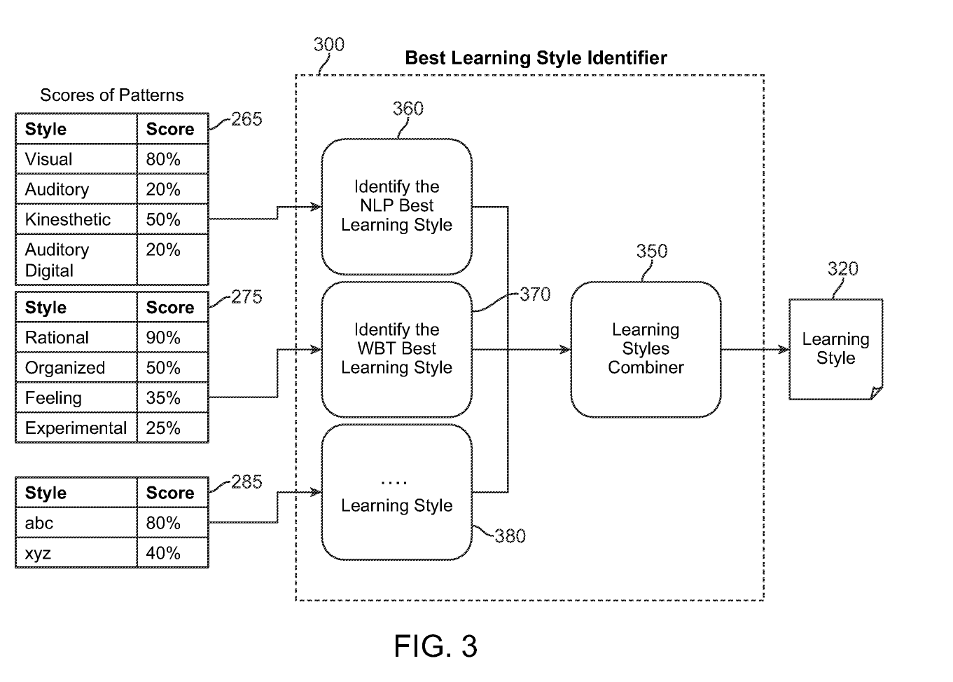

FIG. 3 shows a functional block diagram of an embodiment of the best learning style identifier 300, according to the present invention, receiving the categorization results. The identifier 300 uses the scores of each pattern to analyze the user personality and identify the best learning style for the user based on said pattern. A NLP learning style component 360 identifies the best learning style according to the NLP rules. The NLP identifier 360 uses the NLP pattern scores 265 to analyze the user personality and identify the best learning style for the user based on said pattern. A WBT learning style component 370 identifies the best learning style according to the WBT rules. The WBT identifier 370 uses the WBT pattern scores 275 to analyze the user personality and identify the best learning style for the user based on said pattern. Other learning styles can be added to the system such as Memletics learning styles (this can be achieved by adding some combining rules as well as certain sensors). For example, another identifier 380 uses other pattern scores 285 to analyze the user personality and identify the best learning style for the user based on said pattern.

A combiner 350 combines the identified learning styles to determine a best learning style 320. For example, if the user scores high in the visual part in the case of the NLP pattern, then the best way for learning is to present the eContent in a graphical format. As such, the combiner 350 combines different rules and aspects from the learning styles such as format, layout, structure, pace for progress, etc.

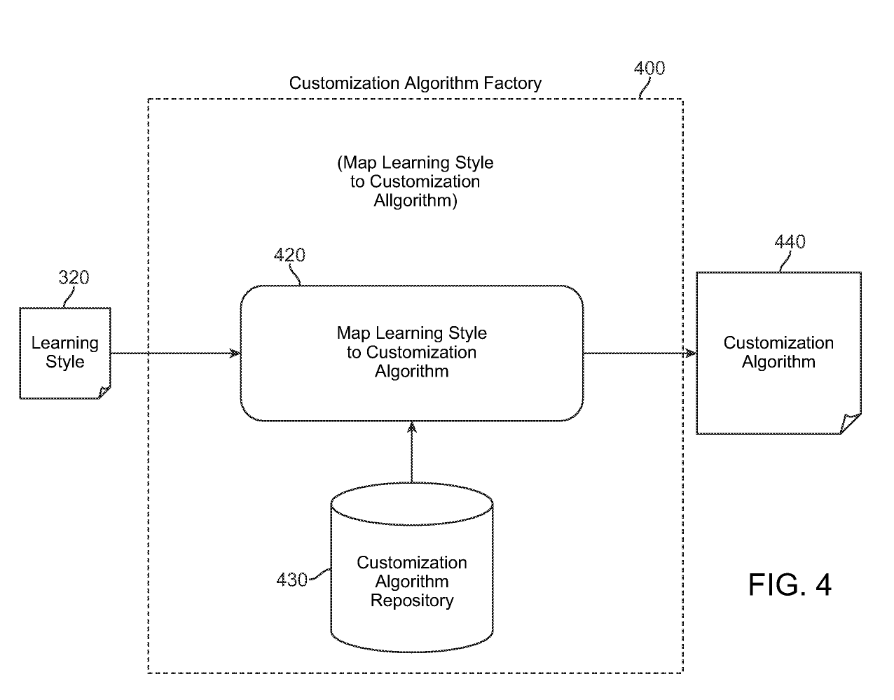

FIG. 4 shows a functional block diagram of the customization algorithm factory module 400, according to an embodiment of the invention. The module 400 includes a mapping function 420 that maps the learning style 320 to one of multiple customization algorithms in a repository (database) 430, thereby selecting a customization algorithm 440 based on the learning style 320. For example, based on the leaning style 320, the selected customization 400 may emphasize video, or images for a visual oriented user. In another example, the customization algorithm 440 may emphasize audio such as narration for an auditory oriented user.

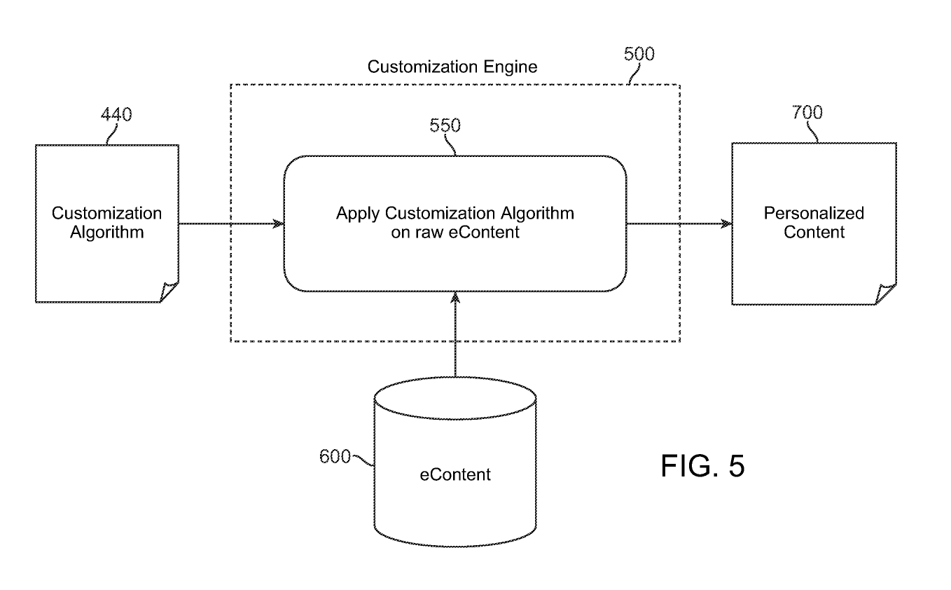

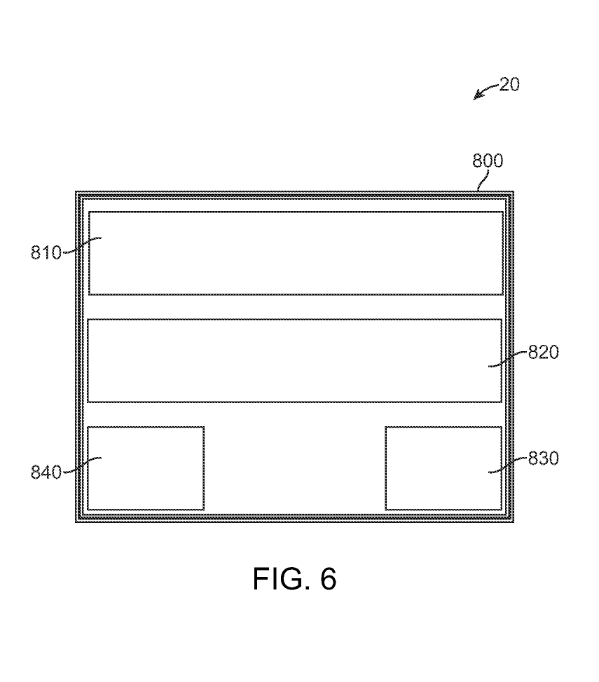

FIG. 5 shows a functional block diagram of the customization engine 500, according to an embodiment of the invention, to customize the eContent 600 using the selected customization algorithm 440. The customization engine 500 includes an application function 550 that applies the selected customization algorithm 440 to the raw eContent 600 and generates the personalized content 700 in the desired format. The personalized eContent may include for example:
1—Text based content (e.g., presentation, story).
2—Automatically generated Audio of the original eContent.
3—Automatically generated video with avatars presenting the original eContent.
4—Any combination of text, audio, graphics and video based on the percentage of each of the thinking modes for the user (FIG. 6).

FIG. 6 illustrates an example 20 of the usage of NLP pattern that is used to select a customization algorithm that customizes (e.g., formats) the original eContent to personalized eContent that emphasizes the most important content suitable for best learning by the user. For example, for a user with a high score in the visual analysis the personalized eContent is displayed on a viewable display screen area 800 as:
Area 810: Best area to place content for a visual user.
Area 820: Best area to place content for an auditory user.
Area 830: Best area to place content for a logic user.
Area 840: Best area to place content for a kinesthetic user.

In another example, using a WBT pattern, for users with quadrant A (rational oriented) preferences, the personalized eContent is preferably customized (e.g., structured) in a logical manner with factual information (e.g., numbers, facts, precise definitions, and/or to-the-point material). Such users may prefer learning through lectures, facts, and details, critical thinking, textbooks and readings. The personalized eContent preferably avoids vague, ambiguous instructions and inefficient use of time material.

For users with quadrant B (organization oriented) preferences, the personalized eContent is preferably customized to provide procedural and/or in depth, step-by-step instructions, history, with timelines. Such users may prefer learning through outlining, checklists, exercises and problem solving with steps, policies and procedures. The personalized eContent preferably avoids disorganization, poor sequencing, hopping around and lack of practice time material.

For users with quadrant C (feeling oriented) preferences, the personalized eContent is preferably customized to provide personal impact stories and/or collaborative activities. Such users may prefer learning through cooperative learning and group discussion, role-playing, and dramatization. The personalized eContent preferably avoids impersonal approaches or examples of materials without sensory input; a sterile learning climate may be preferred.

For users with quadrant D (experimentation oriented) preferences, the personalized eContent is preferably customized to encourage brainstorming and/or free association activities, and visual or graphic mind maps. Such users may prefer learning through brainstorming, metaphors, illustrations and pictures, mind mapping and synthesis, and holistic approaches. The personalized eContent preferably avoids a slow pace and lack of overview/conceptual framework. Other examples are possible.

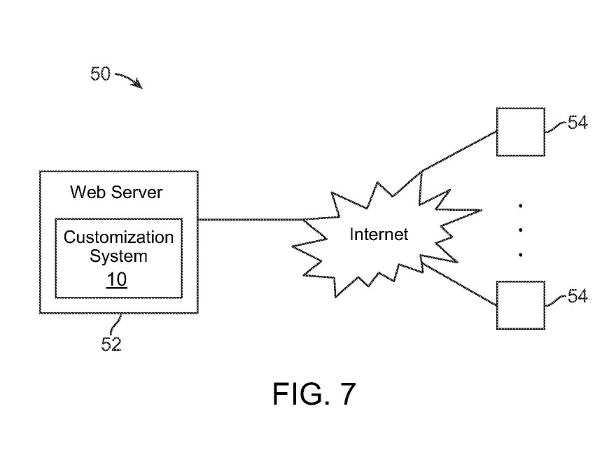

FIG. 7 shows example architecture 50 for delivery of such personalized eContent. A Web server 52 which implements said system 10 (FIG. 1) for generating and delivering personalized eContent to clients 54, wherein in one implementation the clients 54 comprise personal computers connected to the server 52 via the Internet. The Web server 52 obtains user behavior information from a user at a client 54 and according to the function of the automated system 10, generates and delivers personalized eContent to the client 54 for that user to access through a Web browser. As such, each user receives eContent customized to the best style of learning preferred by the user.

As is known to those skilled in the art, the aforementioned example embodiments described above, according to the present invention, can be implemented in many ways, such as program instructions for execution by a processor, as software modules, as computer program product on computer readable media, as logic circuits, as silicon wafers, as integrated circuits, as application specific integrated circuits, as firmware, etc. Though the present invention has been described with reference to certain versions thereof; however, other versions are possible. Therefore, the spirit and scope of the appended claims should not be limited to the description of the preferred versions contained herein. The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information. Computer programs (also called computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor multi-core processor to perform the features of the computer system. Accordingly, such computer programs represent controllers of the computer system.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. An automated method of customizing original content for one or more users, comprising:
obtaining behavior information for a user;
profiling the user based on the user behavior information;
determining a preferred learning style for the user based on the user profiling; and
customizing the original content based on the preferred learning style for the user.

2. The method of claim 1, wherein profiling the user based on the user behavior information further includes analyzing the user behavior information using one or more profiling patterns for profiling the user to determine scores for different behavior categories for the user.

3. The method of claim 2, wherein profiling the user further includes analyzing the user behavior information using a Neural Language Processing (NLP) pattern for profiling the user to determine scores for different behavior categories for the user.

4. The method of claim 2, wherein profiling the user further includes analyzing the user behavior information using a Whole Brain Thinking (WBT) pattern for profiling the user to determine scores for different behavior categories for the user.

5. The method of claim 2, wherein customizing the original content further includes:
determining a preferred learning style for the user based on the user profiling further includes selecting a customization scheme from a scheme repository, based on said scores for different behavior categories for the user; and
applying the selected customization scheme to the original content to generated customized content for the user.

6. The method of claim 5, wherein the customized content is geared to preferred learning style for the user.

7. The method of claim 1 further including providing the customized electronic content to the user via the Internet.

8. The method of claim 1, wherein obtaining user behavior information includes obtaining user behavior information by sensing one or more of: user visual behavior, user linguistic behavior, user social preference behavior, and user logic orientation behavior.

9. A computer program product for customizing original content for one or more users, comprising a computer usable medium including a computer readable program including program instructions, wherein the computer readable program when executed on a computer causes the computer to:
profile a user based on user behavior information for the user;
determine a preferred learning style for the user based on the user profiling; and
customize the original content based on the preferred learning style for the user.

10. The computer program product of claim 9, further including instructions to cause the computer to: analyze the user behavior information using one or more profiling patterns for profiling the user to determine scores for different behavior categories for the user.

11. The computer program product of claim 10, further including instructions to cause the computer to: analyze the user behavior information using a Natural Language Processing (NLP) pattern for profiling the user to determine scores for different behavior categories for the user.

12. The computer program product of claim 10, further including instructions to cause the computer to: analyze the user behavior information using a Whole Brain Thinking (WBT) pattern for profiling the user to determine scores for different behavior categories for the user.

13. The computer program product of claim 10, further including instructions to cause the computer to:
selecting a customization scheme from a scheme repository based on said scores for different behavior categories for the user; and
apply the selected customization scheme to the original content to generated customized content for the user.

14. The computer program product of claim 13, wherein the customized content is geared to preferred learning style for the user.

15. The computer program product of claim 9 further including instructions to cause the computer to: obtain behavior information via a sensor by sensing one or more of: user visual behavior, user linguistic behavior, user social preference behavior, and user logic orientation behavior.

16. A system for customizing original content for one or more users, comprising:
one or more clients, each client representing a user;
a customization server configured for customizing original content for each of one or more clients; and
the server comprising:
a pattern recognizer configured for profiling a user based on the user behavior information;
a learning style identifier configured for determining a preferred learning style for the user based on the user profiling; and
a customizer configured for customizing the original content based on the preferred learning style for the user.

17. The system of claim 16, wherein the pattern recognizer is further configured for analyzing the user behavior information using one or more profiling patterns for profiling the user to determine scores for different behavior categories for the user.

18. The system of claim 17, wherein the pattern recognizer is further configured for analyzing the user behavior information using one or more of:
a Neural Language Processing (NLP) pattern for profiling the user to determine scores for different behavior categories for the user; and
a Whole Brain Thinking (WBT) pattern for profiling the user to determine scores for different behavior categories for the user.

19. The system of claim 17, wherein the customizer includes:
a customization selector configured for determining a preferred learning style for the user based on the user profiling further includes selecting a customization scheme from a scheme repository, based on said scores for different behavior categories for the user; and
a customization engine configured for applying the selected customization scheme to the original content to generated customized content for the user;
wherein the customized content is geared to preferred learning style for the user.

20. The system of claim 16, wherein the server comprises a web server and each client comprises a web client, capable of communicating with the web server via the Internet, such that the web server provides each customized content to a corresponding client via the Internet.
